(19) United States
(12) Patent Application Publication
(10) Pub. No.: US 2025/0145246 A1
(43) Pub. Date: May 8, 2025

(54) ELECTRIFIED CYCLE WITH POWER LIMITING

(71) Applicant: Lectric eBikes, Phoenix, AZ (US)

(72) Inventors: Thomas Blake Jenssen, Phoenix, AZ (US); Matthew Frederick Kosloske, Phoenix, AZ (US)

(21) Appl. No.: 18/388,012

(22) Filed: Nov. 8, 2023

(51) Int. Cl. B62M 6/45; B62J 45/20; B62M 6/60

(52) U.S. Cl. CPC B62M 6/45; B62J 45/20; B62M 6/60

(57) ABSTRACT

An example method generally involves supplying electric power to a motor to thereby cause the motor to drive a drive wheel, varying the electric power supplied to the motor based upon a throttle signal, and limiting the electric power supplied to the motor based upon a selected pedal assist level, thereby preventing the throttle signal from overriding the selected pedal assist level.

### TECHNICAL FIELD

The present disclosure generally relates to electrified cycles, and more particularly but not exclusively relates to systems and methods for controlling such electrified cycles.

### BACKGROUND

Electric cycles such as ebikes typically include a pedal assist system (PAS) that allows the user to select a desired level of pedal assistance to be provided by the electronic control system. While the level of pedal assistance in such cycles is often limited based upon the selected pedal assist levels, such cycles typically do not limit the power provided via the throttle. For these reasons among others, there remains a need for further improvements in this technological field.

### SUMMARY

An exemplary method generally involves supplying electric power to a motor to thereby cause the motor to drive a drive wheel, varying the electric power supplied to the motor based upon a throttle signal, and limiting the electric power supplied to the motor based upon a selected pedal assist level, thereby preventing the throttle signal from overriding the selected pedal assist level. Further embodiments, forms, features, and aspects of the present application shall become apparent from the description and figures provided herewith.

### BRIEF DESCRIPTION OF THE FIGURES

FIG. 1 is a side view of a cycle according to certain embodiments.

FIG. 2 is a front view of a handlebar area according to certain embodiments.

FIG. 3 illustrates a throttle according to certain embodiments.

FIG. 4 illustrates a pedal assistance interface according to certain embodiments.

FIG. 5 is a schematic block diagram of the cycle illustrated in FIG. 1.

FIG. 6 illustrates a display interface according to certain embodiments.

FIG. 7 is a graph illustrating one example set of relationships for throttle signal vs. control signal.

FIG. 8 is a graph illustrating another example set of relationships for throttle signal vs. control signal.

FIG. 9 is a schematic flow diagram of a process according to certain embodiments.

FIG. 10 is a schematic flow diagram of a process according to certain embodiments.

FIG. 11 is a schematic block diagram of a computing device that may be utilized in connection with certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

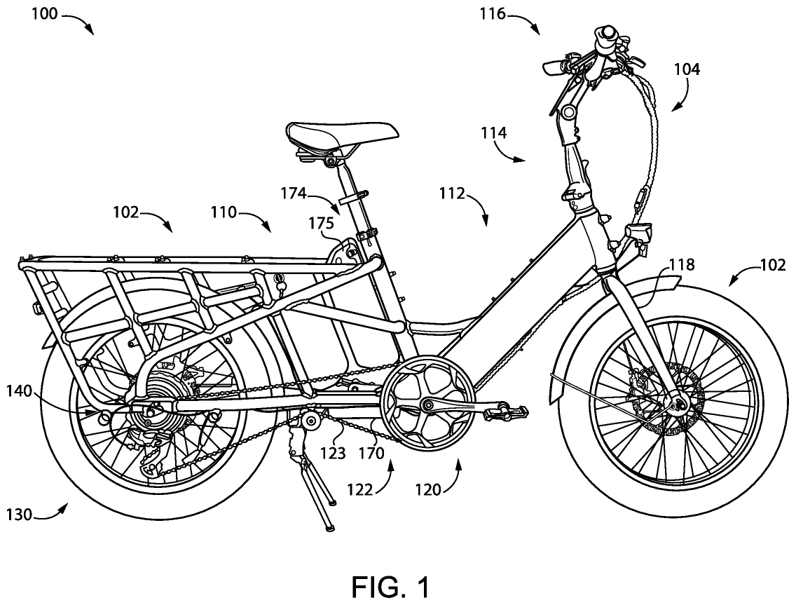

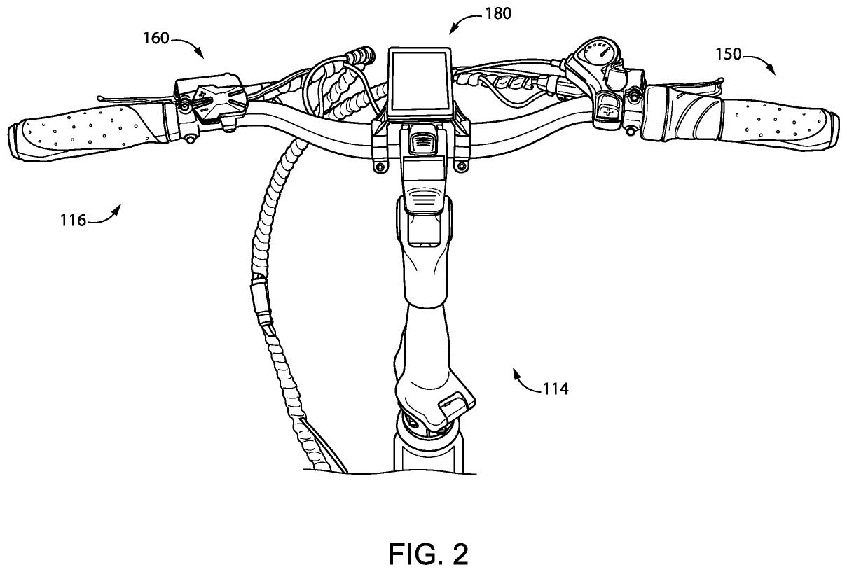

With reference to FIGS. 1 and 2, illustrated therein is an electric cycle 100 according to certain embodiments. The cycle 100 generally includes a frame 110, a set of pedals 120 rotatably mounted to the frame 110, a drive wheel 130 rotatably mounted to the frame 110 and operable to be driven by rotation of the pedals 120, a motor 140 operable to supply an output torque to the drive wheel 130, a user-operable throttle 150 operable to transmit a throttle signal, a user-operable pedal assist interface 160 operable to receive a user selection of a selected pedal assist level, and a control system 170 operable to control one or more aspects of the operation of the cycle 100. In certain embodiments, the cycle 100 may further include a user interface 180 operable to display information and/or receive user selection of one or more options.

While the illustrated cycle 100 is provided in the form of an ebike including one drive wheel 130 and one free wheel 102, it should be appreciated that the concepts described herein may be utilized in connection with other forms of cycles. For example, certain embodiments of the present application relate to an electric tricycle including an additional wheel aligned with the drive wheel.

The frame 110 generally includes a body portion 112 and a stem 114 rotatably coupled with the body portion 112. The stem 114 has an upper portion including handlebars 116 and a lower portion including a front fork 118 that supports a freely rotatable front wheel 102. As is typical of bicycles, the stem 114 is rotatable via the handlebars 116 to permit directional pivoting of the front wheel 102 for steering of the cycle 100.

The pedals 120 are rotatably mounted to the body portion 112 of the frame 110, and are connected with the drive wheel 130 such that the pedals 120 are operable to drive the drive wheel 130. In the illustrated form, the pedals 120 are connected with the drive wheel 130 via a transmission 122 including a chain 123.

The drive wheel 130 is rotatably mounted to the body portion 112 of the frame 110, and is operable to be driven by each of the pedals 120 and the motor 140. Such arrangements are known in the art, and need not be described in further detail herein.

The motor 140 is engaged between the frame 110 and the drive wheel 130, and is configured to supply an output torque to the drive wheel 130. As described herein, the power of the output torque supplied by the motor 140 may vary in response to a control signal, such as one provided by the control system 170. In the illustrated form, the motor 140 is provided in the form of a hub motor, in which a stator is secured to the frame 110 and a rotor is secured to the drive wheel 130. However, it should be appreciated that other forms of motor may be utilized. In certain forms, the motor 140 may be considered to constitute a portion of a pedal assist system (PAS) 104.

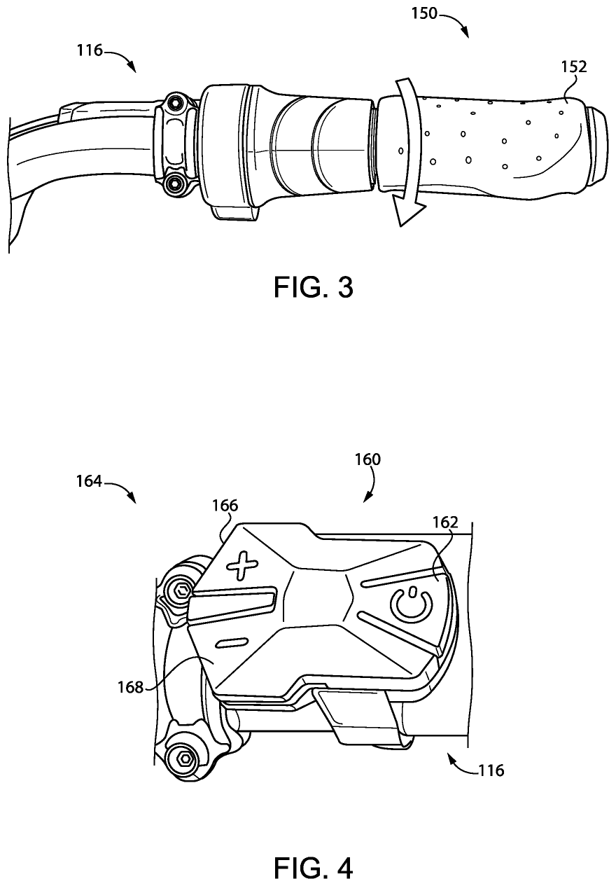

With additional reference to FIG. 3, illustrated therein is one embodiment of a throttle 150 that may be utilized in connection with certain embodiments of the cycle 100. The illustrated throttle 150 is provided in the form known in the art as a half-twist throttle, and includes a grip 152 that is rotatably mounted to one side of the handlebar 116. The grip 152 has a home position and a rotated position, and may be biased toward the home position. When the grip 152 is in the home position, the throttle 150 is unactuated. Rotation of the grip 152 toward its rotated position causes the throttle 150 to transmit a throttle signal that varies based upon the rotational position of the grip 152. In certain embodiments, the throttle signal may be considered as a normalized or scaled quantity that varies from zero (corresponding to the home position) to one (corresponding to the fully rotated position). While the illustrated throttle 150 is provided in the form of a half-twist throttle, it should be appreciated that the throttle 150 may take another form, such as that of a thumb lever throttle.

With additional reference to FIG. 4, illustrated therein is one embodiment of a pedal assist interface 160 that may be utilized in connection with certain embodiments of the cycle 100. The illustrated pedal assist interface 160 is mounted to an opposite side of the handlebar 116 as the throttle 150, and is configured to facilitate user selection of a pedal assist level. The illustrated pedal assist interface 160 generally includes a power button 162 operable to turn the pedal assistance on and off, as well as a selector 164 operable to adjust the pedal assist level. While other forms are contemplated, in the illustrated embodiment, the selector 164 includes a plus button 166 and a minus mutton 168. As will be appreciated, pressing the plus button 166 increases the pedal assist level, and pressing the minus button 168 decreases the pedal assist level. It should also be appreciated that the selector 164 may be provided in another form, such as one including a slider, a toggle, a mechanical actuator, or a touchpad.

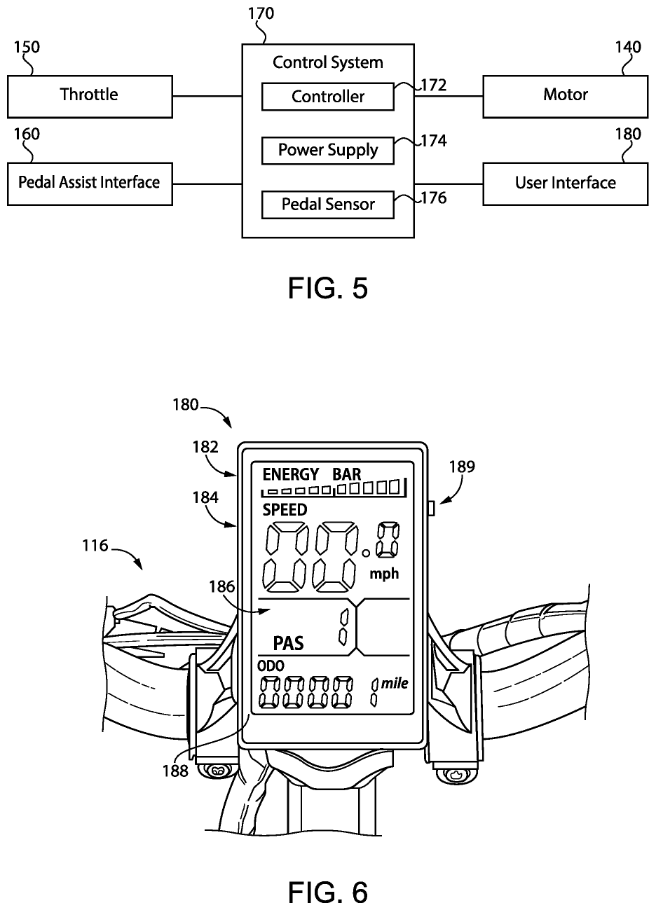

With additional reference to FIG. 5, illustrated therein is a schematic block diagram of the control system 170, along with various electronic components of the cycle 100. The control system 170 generally includes a controller 172 and a power supply 174 such as one or more batteries 175, and may further include a pedal sensor 176 operable to sense rotation of the pedals 120. The control system 170 is in communication with each of the motor 140, the throttle 150, and the pedal assist interface 160, and may further be in communication with the user interface 180. As described herein, the control system 170 is operable to transmit to the motor 140 a control signal that causes the motor 140 to drive the drive wheel 130, and is configured to vary the control signal based upon one or more factors. For example, the control system 170 may vary the control signal based upon a throttle signal generated by the throttle 150 and/or a pedal signal generated by the pedal sensor 176. In certain forms, the pedal sensor 176 may comprise a cadence sensor. In certain embodiments, the control system 170 limits the control signal based upon the selected pedal assist level, for example as described herein. As will be appreciated, varying the control signal may involve varying the voltage and/or the current of the control signal, and the motor 140 may draw power from the power supply 170 according to the control signal. In certain embodiments, the control signal may be considered as a normalized or scaled quantity that varies from zero (corresponding to a minimum control signal value) to one (corresponding to a maximum control signal value).

With additional reference to FIG. 6, illustrated therein is an example user interface 180 that may be utilized in connection with certain embodiments of the cycle 100. The user interface 180 is in communication with the control system 170, which may control the information displayed via the user interface 180. The illustrated user interface 180 generally includes a battery life indicator 182, a speedometer 184, a pedal assist system (PAS) level indicator 186, and an odometer 188. As will be appreciated, the battery life indicator 182 may indicate the amount of power remaining in the batteries 175, the speedometer 184 may indicate the current speed of the cycle 100, and the odometer 188 may display a travel distance. The PAS level indicator 186 may indicate the current level of pedal assistance that has been selected, for example via the pedal assist interface 160. In the illustrated form, the PAS level indicator 186 indicates the PAS level on an integer scale from one (corresponding to minimum pedal assistance) to five (corresponding to maximum pedal assistance). It should be appreciated, however, that other scales may be utilized, and such scales may provide for more or fewer than five levels of pedal assistance.

While the illustrated user interface 180 includes a display in the form of a liquid crystal display (LCD), it should be appreciated that other forms of display may be utilized, such as a light emitting diode (LED) display. In certain embodiments, the user interface 180 may include one or more input devices 189, such as buttons. As described herein, such input devices 189 may facilitate the selection of an operating mode for the cycle 100.

During operation of the cycle 100, the user may select a pedal assist level, for example by manipulating the pedal assist interface 160 until the desired pedal assist level is displayed via the PAS level indicator 186. With the PAS level selected, the user may pedal the cycle 100 via the pedals 120, and the control system 170 may transmit the control signal to the motor 140 to thereby cause the motor 140 to exert a drive torque on the drive wheel 130. As will be appreciated, the control system 170 may vary the control signal based upon the speed at which the pedals 120 are turning. For example, pedaling relatively slowly may result in a relatively low control signal (and thus little assistance from the motor 140), while pedaling more quickly may result in a relatively high control signal (and thus greater assistance from the motor 140). Similarly, the control system 170 may vary the control signal based upon the throttle signal generated by the throttle 150.

The control system 170 is also configured to at least selectively limit the control signal based upon the selected PAS level such that the level of pedal assistance does not exceed the user selection. As described herein, the control system 170 is operable to place an upper limit on the control signal to thereby prevent the throttle 150 from overriding the selected PAS level. In the illustrated form, the cycle 100 has a plurality of modes, including a limiting mode and an override mode. In certain embodiments, the operating mode for the cycle 100 may be selectable via the user interface 180, for example by manipulating the input device(s) 189.

When the cycle 100 is operating in the limiting mode, the control system 170 limits the speed of the cycle based on the selected PAS level. For example, in embodiments in which the control system 170 enables the selection of at least three PAS levels, the control system 170 may limit the cycle 100 to a first maximum speed (e.g., 9 mph) when operating at PAS-1, to a second maximum speed (e.g., 15 mph) when operating at PAS-2, and to a third maximum speed (e.g., 20 mph) when operating at PAS-2. In certain embodiments, one or more of the maximum speeds may be dependent upon the class of the cycle. For example, the third maximum speed may be 20 mph when the cycle 100 is a Class 2 cycle, and 28 mph when the cycle 100 is a Class 3 cycle. In certain embodiments, the third maximum speed may also be utilized as the maximum speed for the PAS-4 and PAS-5 operations.

When the cycle 100 is operating in the override mode, the control system 170 does not limit the speed of the cycle based on the selected PAS level. As one example, the control system 170 may set a single maximum speed for all selected PAS levels. In certain embodiments, the control system 170 may nonetheless limit the speed of the cycle, for example based on the class of the cycle. By way of illustration, the maximum speed for all PAS levels may be a first speed (e.g., 20 mph) when the cycle 100 is a Class 2 cycle, and may be a second speed (e.g., 28 mph) when the cycle 100 is a Class 3 cycle.

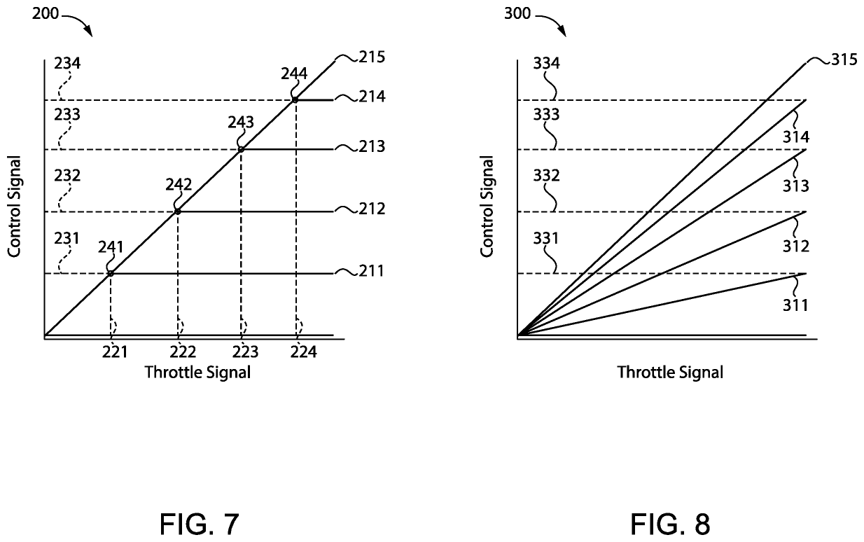

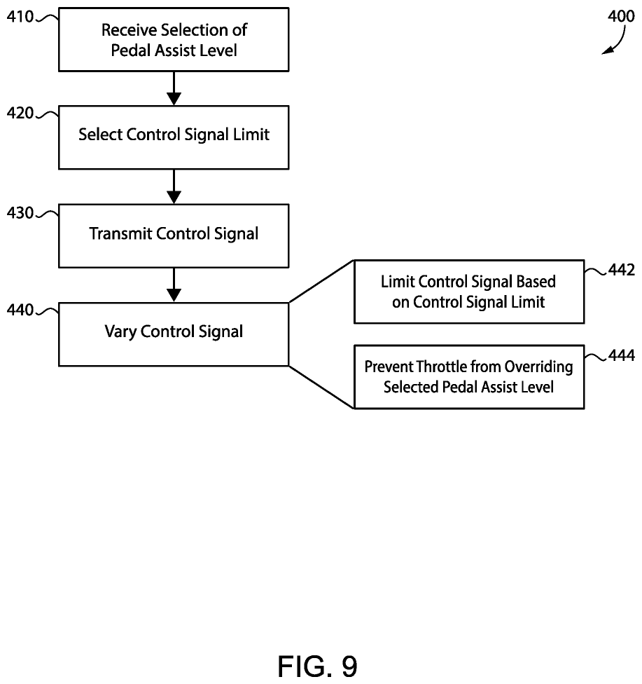

With additional reference to FIG. 7, illustrated therein is a graph 200 illustrating a first example set of relationships between the throttle signal (represented on the horizontal X-axis) and the resulting control signal (represented on the vertical Y-axis) when the cycle 100 is operating in a first mode. As noted above, the control system 170 is configured to vary the control signal based upon the throttle signal and the pedal signal. For example, when the PAS level is selected as a maximum PAS level (e.g., PAS-5), the relationship between the throttle signal and the control signal may be represented by the PAS-5 relationship line 215. While the illustrated relationship between the scaled throttle signal and the scaled control signal is rectilinear, it should be appreciated that the relationship line may instead be at least partially curvilinear.

In addition to the PAS-5 line 215, the graph 200 also illustrates example relationship lines between the scaled throttle signal and the scaled control signal for other PAS level selections. More particularly, the graph 200 illustrates a PAS-4 relationship line 214 corresponding to a selection of the PAS-4 level, a PAS-3 relationship line 213 corresponding to a selection of the PAS-3 level, a PAS-2 relationship line 212 corresponding to a selection of the PAS-2 level, and a PAS-1 relationship line 211 corresponding to a selection of the PAS-1 level. In the illustrated form, each of the non-maximum relationship lines 211-214 rises linearly with increasing throttle signal up to a corresponding limit, and thereafter plateaus. For example, the PAS-1 relationship line 211 follows the PAS-5 relationship line 215 until the throttle signal reaches a first threshold value 221, at which point the PAS-1 relationship line 211 begins to plateau at a first control signal ceiling 231, thereby defining an inflection point 241 for the PAS-1 relationship line 211.

Each of the remaining non-maximum relationship lines 212, 213, 214 follows the PAS-5 relationship line 215 until the throttle signal reaches a corresponding threshold value 222, 223, 224, and thereafter plateaus at a corresponding control signal ceiling 232, 233, 234. Each of the remaining non-maximum relationship lines 212, 213, 214 also has a corresponding inflection point 242, 243, 244, at which point the line transitions from tracking the PAS-5 relationship line 215 to a plateau at the corresponding control signal ceiling 232, 233, 234.

In the illustrated form, the pre-threshold portions of the relationship lines 211-215 have the same slope. As a result, actuating the throttle 150 to a particular degree of actuation (e.g., by rotating the grip 152 a selected number of angular degrees) results in the same level of pedal assistance regardless of the PAS level chosen, so long as the throttle signal does not exceed the threshold value corresponding to the selected PAS level. This arrangement may, for example, be advantageous if the user desires a more consistent throttle feel across different PAS levels.

With additional reference to FIG. 8, illustrated therein is a graph 300 illustrating a second example set of relationships between the throttle signal (represented on the horizontal X-axis) and the resulting control signal (represented on the vertical Y-axis) when the cycle 100 is operating in a second mode. When the PAS level is selected as a maximum PAS level (e.g., PAS-5), the relationship between the throttle signal and the control signal may be represented by the PAS-5 relationship line 315, which is substantially similar to the first PAS-5 relationship line 215. While the illustrated relationship between the scaled throttle signal and the scaled control signal is rectilinear, it should be appreciated that the relationship line may instead be at least partially curvilinear.

In addition to the PAS-5 relationship line 315, the graph 300 also illustrates example relationship lines between the scaled throttle signal and the scaled control signal for other PAS level selections. More particularly, the graph 300 illustrates a PAS-4 relationship line 314 corresponding to a selection of the PAS-4 level, a PAS-3 relationship line 313 corresponding to a selection of the PAS-3 level, a PAS-2 relationship line 312 corresponding to a selection of the PAS-2 level, and a PAS-1 relationship line 311 corresponding to a selection of the PAS-1 level. Each of the non-maximum relationship lines 311-314 also has a corresponding control signal ceiling 331-334 such that the control signal does not exceed the ceiling corresponding to the currently selected PAS level.

In the illustrated form, each of the relationship lines 311-315 has a different slope. The slopes may be selected such that the control signal reaches its maximum value for a particular PAS level as the throttle 150 reaches its fully actuated state (e.g., by rotating the grip 152 to its rotated position). As a result, actuating the throttle 150 to a particular degree of actuation (e.g., by rotating the grip 152 a selected number of angular degrees) results in the same percentage of pedal assistance regardless of the PAS level chosen. For example, rotating the grip 152 halfway from its home position toward its rotated position may result in the control signal being provided as half of the maximum control signal for the selected PAS level, regardless of what that maximum control signal for the selected PAS level is. This arrangement may, for example, be advantageous if the user desires a greater degree of control for the throttle.

It should be appreciated by those skilled in the art that the relationships illustrated in FIGS. 7 and 8 are exemplary only, and may be modified as desired to achieve a suitable throttle-control relationship. It should also be appreciated that the output power of the motor 140 may vary based upon the control signal. In certain forms, one or more of the control signal ceilings (e.g., one or more of the ceilings 231-234 and/or one or more of the ceilings 331-334) may be selected to cause the motor 140 to operate with a particular power. For example, in certain embodiments, the selection of PAS-2 may limit the controller to providing a control signal with a particular amperage, thereby limiting the motor to 400 Watts of pedal assist. In such forms, the cycle 100 may limit the control signal to a value corresponding to 400 W such that the throttle 150 cannot cause the motor 140 to draw in excess of 400 W from the power supply 174. As such, each of the control signal ceilings may be considered to correspond to a respective power ceiling such that the motor 140 is prevented from drawing motive power in excess of the power ceiling.

With additional reference to FIG. 8, an exemplary process 400 that may be performed using the cycle 100 is illustrated. Blocks illustrated for the processes in the present application are understood to be examples only, and blocks may be combined or divided, and added or removed, as well as re-ordered in whole or in part, unless explicitly stated to the contrary. Unless specified to the contrary, it is contemplated that certain blocks performed in the process 400 may be performed wholly by the control system 170, or that the blocks may be distributed among one or more of the elements and/or additional devices or systems that are not specifically illustrated in FIGS. 1-6. Additionally, while the blocks are illustrated in a relatively serial fashion, it is to be understood that two or more of the blocks may be performed concurrently or in parallel with one another. Moreover, while the process 400 is described herein with specific reference to the cycle 100 illustrated in FIGS. 1-6, it is to be appreciated that the process 400 may be performed with cycles having additional and/or alternative features.

The process 400 may include block 410, which generally involves receiving a user selection of a pedal assist system (PAS) level. In certain forms, block 410 may involve receiving the user selection via a pedal assist interface of the cycle 100, such as the pedal assist interface 160. It is also contemplated that the PAS level may be selected via an external device in communication with the control system 170, such as a mobile device. As will be appreciated, block 410 may involve selecting the selected PAS level from a plurality of PAS level options. In the illustrated form, block 410 involves receiving the selection of the PAS level from five available PAS levels. It should be appreciated, however, that block 410 may involve receiving the selection of the PAS level from more or fewer available PAS levels.

The process 400 may include block 420, which generally involves selecting a control signal limit. More particularly, block 420 generally involves selecting the control signal limit based upon the selected PAS level, the selection of which may be received in block 410. In certain forms, the control signal limit is a control signal ceiling, for example as described above. In certain forms, block 420 may involve selecting the control signal limit such that the control signal limit corresponds to a desired power limit for the motor 140. For example, in instances where the selected PAS level is PAS-2, block 420 may involve selecting the control signal limit as the value that causes the motor 140 to draw the amount of power desired for PAS-2, such as about 400 W.

The process 400 may include block 430, which generally involves transmitting a control signal that causes operation of the motor 140. For example, block 430 may involve transmitting the control signal in response to actuation of the throttle 150 and/or pedaling of the pedals 120. As will be appreciated, the control signal may cause the motor 140 to draw power from the power supply 174 in an amount corresponding to the control signal.

The process 400 may include block 440, which generally involves varying the control signal based at least in part upon a received throttle signal, such as a throttle signal transmitted by the throttle 150. In certain embodiments, the varying of the control signal is further based upon a received pedal signal, such as a pedal signal transmitted by the pedal sensor 176. As will be appreciated, varying the control signal causes a corresponding variation in the power being drawn by the motor 140. Block 440 may involve block 442 and/or block 444. Block 442 generally involves generally involves limiting the control signal based on the control signal limit. For example, block 442 may involve preventing the control signal from exceeding a control signal ceiling. Block 444 generally involves preventing the throttle 150 from overriding the selected PAS level, for example by limiting the control signal.

As will be appreciated, the varying of block 440 may also be based upon the user selection of an override mode or a limiting mode. For example, when the limiting mode is selected, the varying of block 440 may involve limiting the control signal based upon the PAS level to thereby prevent the cycle 100 from exceeding a speed cap corresponding to the selected PAS level. By contrast, when the override mode is selected, the varying of block 440 may involve limiting the control signal to prevent the cycle 100 from exceeding a particular speed cap regardless of the selected PAS level.

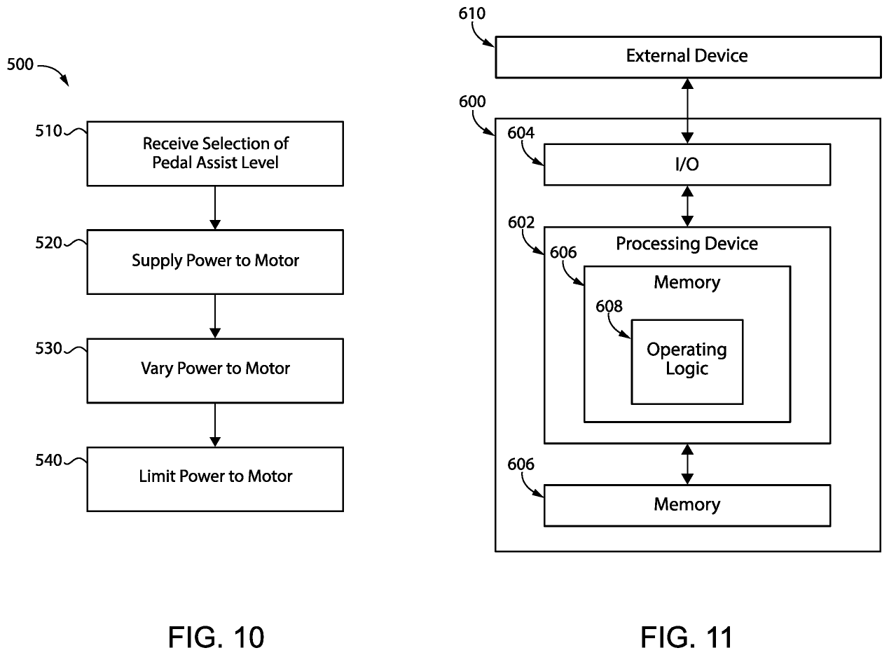

With additional reference to FIG. 10, an exemplary process 500 that may be performed using the cycle 100 is illustrated. Blocks illustrated for the processes in the present application are understood to be examples only, and blocks may be combined or divided, and added or removed, as well as re-ordered in whole or in part, unless explicitly stated to the contrary. Unless specified to the contrary, it is contemplated that certain blocks performed in the process 400 may be performed wholly by the control system 170, or that the blocks may be distributed among one or more of the elements and/or additional devices or systems that are not specifically illustrated in FIGS. 1-6. Additionally, while the blocks are illustrated in a relatively serial fashion, it is to be understood that two or more of the blocks may be performed concurrently or in parallel with one another. Moreover, while the process 500 is described herein with specific reference to the cycle 100 illustrated in FIGS. 1-6, it is to be appreciated that the process 500 may be performed with cycles having additional and/or alternative features.

The process 500 may include block 510, which generally involves receiving selection of a pedal assist level. In certain embodiments, block 510 may involve receiving the selection of the pedal assist level at the control system 170 via the pedal assist interface 160. In certain embodiments, block 510 may further include selecting a power ceiling based upon the selected pedal assist level.

The process 500 may include block 520, which generally involves supplying power to a motor to thereby cause the motor to drive a drive wheel. For example, block 520 may involve supplying power from the power supply 174 to the motor 140 to thereby cause the motor 140 to drive the drive wheel 130. As one example, block 520 may involve the control system 170 transmitting to the motor 140 a control signal operative to cause the motor 140 to draw power from the power supply 174. As will be appreciated, the motive power exerted by the motor 140 may correspond to the control signal such that varying the control signal results in a corresponding variation in the motive power.

The process 500 may include block 530, which generally involves varying power to the motor based upon a throttle signal, thereby varying the motive power. For example, block 530 may involve varying the control signal as a function of the actuation of the throttle 150. In certain forms, block 530 may further involve varying the power to the motor based upon a pedal signal, such as one generated by the pedal sensor 176.

The process 500 may include block 540, which generally involves limiting the power supplied to the motor to thereby prevent the throttle signal from overriding the selected pedal assist level. In certain embodiments, block 540 may involve limiting the power drawn by the motor based on a power ceiling, such as a power ceiling selected in response to the selected pedal assist level in block 510. As a result of the limiting of block 540, the throttle 150 is at least selectively inoperable to override the selected pedal assist level.

While certain embodiments have been described in association with limiting the power consumed by the motor 140 during actuation of the throttle 150, it is also contemplated that the power consumed by the motor 140 may be limited based on the selected PAS level in circumstances in which the throttle 150 is not actuated (or is omitted entirely). More particularly, the power consumed by the motor 140 may be limited even when such power is being utilized as a result of the pedal sensor 176 detecting rotation of the pedals 120. For example, the control system 170 may limit the power draw of the motor 140 to a first amperage limit (e.g., 4 amp) when PAS-1 is selected, and may limit the power draw of the motor 140 to a second amperage limit (e.g., 10 amp) when PAS-2 is selected. Additional or alternative PAS levels may have additional or alternative amperage limits associated therewith. For example, PAS-3 may be associated with a third amperage limit (e.g., 15 amp), PAS-4 may be associated with a fourth amperage limit (e.g., 20 amp), and PAS-5 may be associated with a fifth amperage limit (e.g., 24 amp).

As noted above, in certain forms, the control system 170 may limit the speed of the cycle 100 based on the selected PAS level. It should be appreciated that such limiting may be utilized in combination with the above-described amperage limits. For example, when the user is pedaling while PAS-1 is selected, the control system 170 may cause the motor 140 to draw a first power (e.g., 4 amp) until the cycle 100 reaches a first speed (e.g., 9 mph). Similarly, when the user is pedaling while PAS-2 is selected, the control system 170 may cause the motor 140 to draw a second power (e.g., 10 amp) until the cycle 100 reaches a second speed (e.g., 15 mph). In certain forms, the first speed and the second speed may be the same speed (e.g., 20 mph or 28 mph).

In the interest of elucidating the above-described principles, an example use case scenario will now be provided. A user of the cycle 100 begins by selecting a desired PAS level, which in this case will be selected as PAS-3. The user actuates the throttle 150, and in response, the control system 170 causes the motor 140 to draw power corresponding to the amperage limit associated with PAS-3 (e.g., 15 amp) until the cycle 100 reaches a speed corresponding to the speed limit associated with PAS-3 (e.g., 20 mph). The user then releases the throttle and begins pedaling, thereby activating the pedal sensor 176. In response, the control system 170 again causes the motor 140 to draw power corresponding to the amperage limit associated with PAS-3 (e.g., 15 amp) until the cycle 100 reaches a speed corresponding to the speed limit associated with PAS-3 (e.g., 20 mph). Since the motor 140 draws the same amount of power when the throttle 140 is actuated as when the pedal sensor 176 is actuated, the user is provided with a smooth transition from throttle-based power to pedal-based power.

Referring now to FIG. 11, a simplified block diagram of at least one embodiment of a computing device 600 is shown. The illustrative computing device 600 depicts at least one embodiment of a control system and/or controller that may be utilized in connection with the control system 170 and/or controller 172 illustrated in FIG. 5.

Depending on the particular embodiment, the computing device 600 may be embodied as a server, desktop computer, laptop computer, tablet computer, notebook, netbook, Ultrabook™, mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 600 includes a processing device 602 that executes algorithms and/or processes data in accordance with operating logic 608, an input/output device 604 that enables communication between the computing device 600 and one or more external devices 610, and memory 606 which stores, for example, data received from the external device 610 via the input/output device 604.

The input/output device 604 allows the computing device 600 to communicate with the external device 610. For example, the input/output device 604 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Bluetooth Low Energy (BLE), Wi-Fi®, WiMAX, etc.) to effect such communication depending on the particular computing device 600. The input/output device 604 may include hardware, software, and/or firmware suitable for performing the techniques described herein.

The external device 610 may be any type of device that allows data to be inputted or outputted from the computing device 600. For example, in various embodiments, the external device 610 may be embodied as the motor 140, the throttle 150, the pedal assist interface 160, the pedal sensor 176 and/or the user interface 180. Further, in some embodiments, the external device 610 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 610 may be integrated into the computing device 600.

The processing device 602 may be embodied as any type of processor(s) capable of performing the functions described herein. In particular, the processing device 602 may be embodied as one or more single or multi-core processors, microcontrollers, or other processor or processing/controlling circuits. For example, in some embodiments, the processing device 602 may include or be embodied as an arithmetic logic unit (ALU), central processing unit (CPU), digital signal processor (DSP), and/or another suitable processor(s). The processing device 602 may be a programmable type, a dedicated hardwired state machine, or a combination thereof. Processing devices 602 with multiple processing units may utilize distributed, pipelined, and/or parallel processing in various embodiments. Further, the processing device 602 may be dedicated to performance of just the operations described herein, or may be utilized in one or more additional applications. In the illustrative embodiment, the processing device 602 is of a programmable variety that executes algorithms and/or processes data in accordance with operating logic 608 as defined by programming instructions (such as software or firmware) stored in memory 606. Additionally or alternatively, the operating logic 608 for processing device 602 may be at least partially defined by hardwired logic or other hardware. Further, the processing device 602 may include one or more components of any type suitable to process the signals received from input/output device 604 or from other components or devices and to provide desired output signals. Such components may include digital circuitry, analog circuitry, or a combination thereof.

The memory 606 may be of one or more types of non-transitory computer-readable media, such as a solid-state memory, electromagnetic memory, optical memory, or a combination thereof. Furthermore, the memory 606 may be volatile and/or nonvolatile and, in some embodiments, some or all of the memory 606 may be of a portable variety, such as a disk, tape, memory stick, cartridge, and/or other suitable portable memory. In operation, the memory 606 may store various data and software used during operation of the computing device 600 such as operating systems, applications, programs, libraries, and drivers. It should be appreciated that the memory 606 may store data that is manipulated by the operating logic 608 of processing device 602, such as, for example, data representative of signals received from and/or sent to the input/output device 604 in addition to or in lieu of storing programming instructions defining operating logic 608. As illustrated, the memory 606 may be included with the processing device 602 and/or coupled to the processing device 602 depending on the particular embodiment. For example, in some embodiments, the processing device 602, the memory 606, and/or other components of the computing device 600 may form a portion of a system-on-a-chip (SoC) and be incorporated on a single integrated circuit chip.

In some embodiments, various components of the computing device 600 (e.g., the processing device 602 and the memory 606) may be communicatively coupled via an input/output subsystem, which may be embodied as circuitry and/or components to facilitate input/output operations with the processing device 602, the memory 606, and other components of the computing device 600. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 600 may include other or additional components, such as those commonly found in a typical computing device (e.g., various input/output devices and/or other components), in other embodiments. It should be further appreciated that one or more of the components of the computing device 600 described herein may be distributed across multiple computing devices. In other words, the techniques described herein may be employed by a computing system that includes one or more computing devices. Additionally, although only a single processing device 602, I/O device 604, and memory 606 are illustratively shown in FIG. 11, it should be appreciated that a particular computing device 600 may include multiple processing devices 602, I/O devices 604, and/or memories 606 in other embodiments. Further, in some embodiments, more than one external device 610 may be in communication with the computing device 600.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An electric cycle, comprising:
a frame;
a set of pedals rotatably mounted to the frame;
a drive wheel rotatably mounted to the frame, wherein the drive wheel is operable to be driven by rotation of the pedals;
a motor operable to supply an output power to the drive wheel, the output power varying based upon a control signal;
a throttle configured to transmit a throttle signal; and
a control system configured to vary the control signal based upon the throttle signal;
wherein the control system is operable to limit the control signal based upon a selected pedal assist level to thereby at least selectively prevent the throttle from overriding the selected pedal assist level.

2. The electric cycle of claim 1, wherein to limit the control signal based upon the selected pedal assist level comprises setting an upper boundary for the control signal.

3. The electric cycle of claim 1, wherein the control system is further configured to vary the control signal based upon rotation of the pedals.

4. The electric cycle of claim 1, wherein the throttle is inoperable to override the pedal assist level.

5. The electric cycle of claim 1, wherein the control system is operable in each of a limiting mode and an override mode;
wherein the control system, when operating in the limiting mode, is configured to prevent the electric cycle from overriding a first speed cap selected based upon the selected pedal assist level; and
wherein the control system, when operating in the override mode, is configured to prevent the electric cycle from overriding a second speed cap.

6. The electric cycle of claim 1, wherein the control system is configured to prevent the control signal from exceeding a first control signal ceiling in response to user selection of a first pedal assist level;
wherein the control system is configured to prevent the control signal from exceeding a second control signal ceiling in response to user selection of a second pedal assist level; and
wherein the first control signal ceiling is different from the second control signal ceiling.

7. The electric cycle of claim 1, further comprising a pedal assist interface operable to receive a user selection of the selected pedal assist level.

8. A method of operating an electric cycle comprising a drive wheel, a motor operable to exert torque on the drive wheel, and a throttle operable to generate a throttle signal, the method comprising:
transmitting, to the motor, a control signal that causes the motor to rotate a drive wheel with a power that varies based upon the control signal;
varying the control signal based upon the throttle signal;
selecting, based upon a selection of a pedal assist level, a control signal limit; and
limiting the control signal based on the control signal limit, thereby preventing the throttle from overriding the selected pedal assist level.

9. The method of claim 8, further comprising selectively operating the electric cycle in an selected mode selected from a limiting mode and an override mode;
wherein operating the electric cycle in the limiting mode further comprises limiting a speed of the electric cycle to a first speed cap selected based upon the selected pedal assist level; and
wherein operating the electric cycle in the override mode further comprises limiting the speed of the electric cycle to a second speed cap.

10. The method of claim 8, wherein selecting the control signal limit comprises:
selecting a first control signal limit in response to selection of a first pedal assist level; and
selecting a second control signal limit different from the first control signal limit in response to selection of a second pedal assist level different from the first pedal assist level.

11. The method of claim 8, wherein the control signal limit is a control signal ceiling.

12. The method of claim 8, wherein the cycle further comprises a pedal sensor operable to generate a pedal signal; and
wherein varying the control signal based on the throttle signal comprises varying the control signal based upon the throttle signal and the pedal signal.

13. A method of operating an electric cycle, comprising:
supplying electric power to a motor to thereby cause the motor to drive a drive wheel;
varying the electric power supplied to the motor based upon an input signal; and
limiting the electric power supplied to the motor based upon a selected pedal assist level, thereby preventing the input signal from overriding the selected pedal assist level.

14. The method of claim 13, wherein the electric cycle comprises the drive wheel, the motor, and an input device operable to transmit the input signal;
wherein the input device comprises at least one of a pedal sensor or a throttle.

15. The method of claim 13, further comprising selecting a power ceiling based upon the selected pedal assist level;
wherein supplying the electric power to the motor causes the motor to drive the drive wheel with a motive power; and
wherein limiting the electric power supplied to the motor based upon the selected pedal assist level comprises preventing the motive power from exceeding the power ceiling.

16. The method of claim 13, further comprising receiving a user selection of the selected pedal assist level.

17. The method of claim 13, wherein the input signal comprises a pedal signal.

18. An electric cycle, comprising:
a frame;
a set of pedals rotatably mounted to the frame;
a drive wheel rotatably mounted to the frame, wherein the drive wheel is operable to be driven by rotation of the pedals;
a motor operable to supply an output power to the drive wheel, the output power varying based upon a control signal;
a pedal sensor configured to transmit a pedal signal in response to rotation of the pedals; and
a control system configured to vary the control signal based upon the pedal signal;
wherein the control system is configured to limit the control signal based upon a selected pedal assist level to thereby at least selectively prevent the pedal signal from overriding the selected pedal assist level.

19. The electric cycle of claim 18, wherein the control system is configured to cause the motor to draw a first current in response to the pedal signal when a first pedal assist level is selected;
wherein the control system is configured to cause the motor to draw a second current in response to the pedal signal when a second pedal assist level is selected; and
wherein the first current and the second current are of different amperages.

20. The electric cycle of claim 18, wherein the control system is further configured to limit a speed of the cycle based upon the selected pedal assist level.

21. The electric cycle of claim 18, wherein limiting the control signal based upon the selected pedal assist level prevents the motor from drawing current in excess of an amperage limit corresponding to the selected pedal assist level.
